(19) United States
(12) Patent Application Publication
(10) Pub. No.: US 2014/0319879 A1
(43) Pub. Date: Oct. 30, 2014

(54) Method for Producing a Hollow Profile and Hollow Profile Component

(71) Applicant: Daimler AG, Stuttgart (DE)

(72) Inventor: Eckhard Reese, Apensen (DE)

(73) Assignee: Daimler AG, Stuttgart (DE)

(21) Appl. No.: 14/359,857

(22) PCT Filed: Oct. 18, 2012
(86) PCT No.: PCT/EP2012/004367

§ 371 Date: May 21, 2014

(30) Foreign Application Priority Data
Nov. 22, 2011 (DE) 10 2011 119 226.7

(51) Int. Cl. B29D 23/00; B62D 29/04; B29C 63/00

(52) U.S. Cl. CPC B29D 23/00; B29C 63/0021; B62D 29/043; B29C 70/021
USPC 296/193.02; 156/149; 264/258

(57) ABSTRACT

A method for the production of a hollow profile, which is a cockpit cross-member for a motor vehicle, involves braiding endless fibers around a core that forms the inner contour of the hollow profile to produce a fibrous hollow structure. After the braiding, the fibrous hollow structure is, in the elastic state, removed from the core in a non-destructive manner, molded into an end contour by application of internal pressure and overmolded with a plastic.

### BACKGROUND AND SUMMARY OF THE INVENTION

Exemplary embodiments of the invention relate to a method for the production of a hollow profile and a hollow profile component.

For lightweight construction considerations, components made from fiber-reinforced plastics are increasingly used in motor vehicle construction. Typically, such components can only be produced in the form of plates or hollow profiles that run in a straight line and do not have an undercut. Complexly-shaped components, for example cockpit cross-members, which have to bear a plurality of attachment parts such as the steering console, the central console, the airbag holder and the tunnel brace, are therefore designed to have multiple parts, even in lightweight construction, and are subsequently joined together. During the construction of hollow profile components, no firmly bonded connection between the individual regions of the component is possible here, such that the stability is not always optimal.

German patent document DE 10 2007 057 198 A1 discloses producing complexly-shaped fiber-reinforced hollow profile components by applying resinated endless fibers to a lost mold in a positive and stress-optimized manner, which can take place, for example, by weaving, braiding, stitching or sewing. Then the fibrous material is cured under formation of the desired reinforced hollow girder and the lost mold is removed destructively.

During this procedure, the production of complexly-shaped hollow bodies is also enabled, but is afflicted with several disadvantages. In particular, wet, i.e. resin-impregnated, fibers are difficult to treat, wherein, for example, the processing machines also have to be cleaned regularly. Also, the provision of a lost core for the production of each individual hollow profile is both time-consuming and cost-intensive. The same applies for the destruction and disposal of the lost core.

Exemplary embodiments of the present invention are directed to a method that enables the production of complexly-shaped hollow profiles from fiber composite materials in a particularly simple and economical manner. Exemplary embodiments of the present invention are also directed to a hollow profile component that is particularly resistant to exertions of force during the driving operation and which, at the same time, can be produced particularly economically and simply.

In such a method for the production of a hollow profile, in particular a cockpit cross-member for a motor vehicle, endless fibers are braided around a core that represents the inner contour of the hollow profile to be produced, to form a fibrous hollow structure. Here, provision is made according to the invention for the fibrous hollow structure to be removed, in the elastic state, from the core without destruction after the braiding, to be molded into an end contour by application of internal pressure and to be overmolded with a plastic. Also, after the overmolding, the workpiece can, in the elastic state, be removed from the core.

In other words, the inner contour of the hollow profile can be represented by a durable core, in contrast to the prior art. Due to the elastic nature of the braided fibrous hollow structure, a complexly-shaped durable core, which has, for example, undercuts, branches or suchlike, can be removed from the fibrous hollow structure without destruction. The additional effort of providing newer and newer lost cores, as well as the laborious destruction and disposal of the cores, is therefore dispensed with.

The core preferably has at least one branch. This enables the production of particularly complexly-shaped hollow profiles, which, as well as the actual force-absorbing and force-conducting carrier structure, comprises additional functional elements that are formed as a single part and are firmly-bonded, such as additional struts, consoles or suchlike.

In a further embodiment of the invention, the fibrous hollow structure is brought into a shape that is close to the end contour before the application of internal pressure by means of at least one handling device, in particular a robot. This enables the inner space of the fibrous hollow structure to be reliably and completely applied with pressure, without folds, kinks or suchlike in the fibrous hollow structure having a negative effect on the design. With this, a particularly procedurally-reliable molding of the fibrous hollow structure into the desired end contour is thus possible.

Advantageously, hybrid rovings made from reinforcing fibers and thermoplastic matrix fibers are used as endless fibers. Alternatively, reinforcing fibers that are coated with thermoplastic matrix material, so-called towpregs, can also be used. In both cases, the matrix material is thus inserted into the braid in the fixed or paste-like state. The problems in processing resin-impregnated reinforcing fibers are hereby dispensed with. Carbon fibers, glass fibers or suchlike can, for example, be used as reinforcing fibers. Several types of reinforcing fibers, for example steel or aramid fibers, can also be interwoven in a single roving as well as the carbon fibers. PA or PPA, for example, can be used as the thermoplastic matrix material. In both cases, a very fine, homogeneous distribution of reinforcing and matrix fibers can be achieved, which later enables a faster and improved consolidation due to the short flow path of the matrix material. The corresponding hybrid rovings or towpregs additionally enable a particularly accurate, axially parallel configuration of the fibers without twists or knots, which configures the force flow particularly well in the hollow profile.

To overmold the fibrous hollow structure, a short-fiber-reinforced plastic, particularly preferably a thermoplastic, is preferably used. Thus, particularly high strength can be achieved. As well as the overmolding itself, a fusing of the matrix material of the hybrid rovings or towpregs thus takes place at the same time, such that a homogeneous hollow profile body, which is reinforced by both long and short fibers, arises, which has excellent mechanical properties.

In a further embodiment of the invention, wall strengths with local differences are produced by braiding the fibrous hollow structure. This enables a flux-optimized adaptation of the hollow profile to the actual operating stresses, such that, in the case of particularly low component weight, a particularly high level of resistance to stresses occurring during the driving operation is achieved.

Advantageously, before the application of high internal pressure, the fibrous hollow structure is heated above the glass transition temperature and to just before the melting point of the matrix material, such that this is capable of optimum flow and can be molded and the end contour is adapted optimally.

Advantageously, during the overmolding of the fibrous hollow structure, at least one depositor is, in addition, overmolded as well. Such depositors, which can also be produced from fiber composite materials, may also form functional components such as consoles, girders, supports, struts or suchlike on the hollow profile. The overmolding can thus, according to known methods, be carried out in common injection molding tools.

The invention furthermore relates to a hollow profile component, in particular a cockpit cross-member for a motor vehicle, which has a hollow profile having at least one branch, which is reinforced by a continuous, branched fiber network. Here, provision is made according to the invention for the at least one branch to form a functional part, in particular a console, a tunnel brace or suchlike. By using a continuous, branched fiber network, a particularly stable hollow profile component is obtained. At the same time, by using the at least one branch to form the functional part, a particularly high level of functional integration can be achieved. It is hereby possible to dispense with a non-firmly bonded connection of the functional parts, for example by overmolding or other mechanical joining methods that would potentially weaken the hollow profile component.

### BRIEF DESCRIPTION OF THE DRAWING FIGURES

The invention and its embodiments are to be illustrated in greater detail below with the aid of the figure. Here are shown:

FIG. 1 a perspective view of an exemplary embodiment of a cockpit cross-member according to the invention;

FIG. 2 a cross-sectional depiction of a hybrid roving;

FIG. 3 a cross-sectional depiction of a towpreg;

FIG. 4 a braiding machine that can be used within the framework of an exemplary embodiment of a method according to the invention;

FIG. 5 a braid produced by means of the braiding machine according to FIG. 4;

FIGS. 6a and 6b are perspective views of a durable core that can be used within the framework of an exemplary embodiment of the method according to the invention;

FIG. 7 a sectional depiction through a branching region of an exemplary embodiment of a cockpit cross-member according to the invention;

FIG. 8 a schematic view of a robotic system for aligning a fibrous hollow body produced within the framework of a method according to the invention into a location that is close to the end contour;

FIG. 9 a schematic depiction of potential positions for depositors during the overmolding of the fibrous hollow body according to FIG. 8;

FIG. 10 a molding tool for overmolding the fibrous hollow body;

FIG. 11 a view of a detailed structure of the exemplary embodiment of a cockpit cross-member according to the invention;

FIG. 12, 13 two alternative views of a depositor for forming a steering console in one exemplary embodiment of a cockpit cross-member according to the invention;

FIG. 14, 15 two perspective views of a further depositor for a steering console for one exemplary embodiment of a cockpit cross-member according to the invention, and

FIG. 16 a perspective view of a depositor for a support structure for a passenger airbag of one exemplary embodiment of a cockpit cross-member according to the invention.

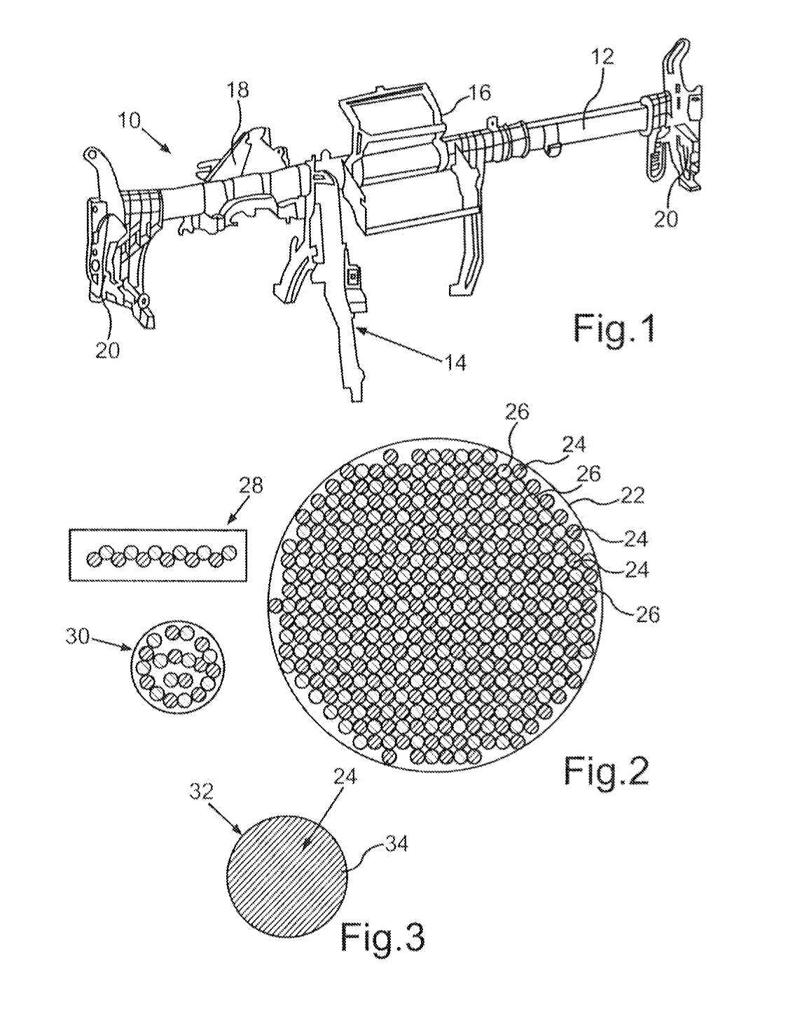

### DETAILED DESCRIPTION

A cockpit cross-member denoted as a whole by 10 for a motor vehicle comprises a transverse strut 12, which is formed as a hollow profile, as well as a tunnel brace 14, which is also hollow profiled, which supports the cockpit cross-member 10 on the tunnel of the motor vehicle. To create a particularly stable cockpit cross-member 10, the transverse strut 12 and the tunnel brace 14 are produced as single-part, branched hollow bodies from a fiber-reinforced plastic. Further overmolded attachment parts, such as a support frame 16 for a passenger airbag or a steering console 18, are applied to the transverse strut 12. Also, fastening consoles 20 for the lateral fastening of the cockpit cross-member 10 are connected to the cockpit cross-member 10 as overmolded plastic parts.

Hybrid rovings, as depicted in FIG. 2, are applied for the production of such a branched fiber composite hollow profile. Such a hybrid roving 22 comprises a plurality of reinforcing fibers 24, for example carbon fibers, which are bundled together with matrix fibers 26 made from a thermoplastic material such as PPA. Here, both a regularly alternating fiber arrangement 28 and a disordered fiber arrangement 30 are possible. The advantage of hybrid rovings 22 is that the matrix material is already contained in the preform. Due to the very fine, homogeneous distribution of the reinforcing and matrix fibers, the matrix material is already located in the braid before the braiding process. This enables a fast and particularly reliable consolidation due to short flow paths of the subsequently fused matrix fibers 26. In addition, the fibers 24, 26 are arranged axially parallel and without twists or knots, which significantly increases the resilience of the material. Alternatively, the so-called towpregs 32 depicted in FIG. 3 can also be used. Here, these are reinforcing fibers 24 that are coated with a sheathing 34 made from matrix material. Particularly short flow paths also arise here during the subsequent consolidation.

The reinforcing fibers 24 can be formed as carbon fibers, glass fibers or suchlike. Also, mixed fiber compositions, for example with additional, integrated steel or aramid fibers, are possible.

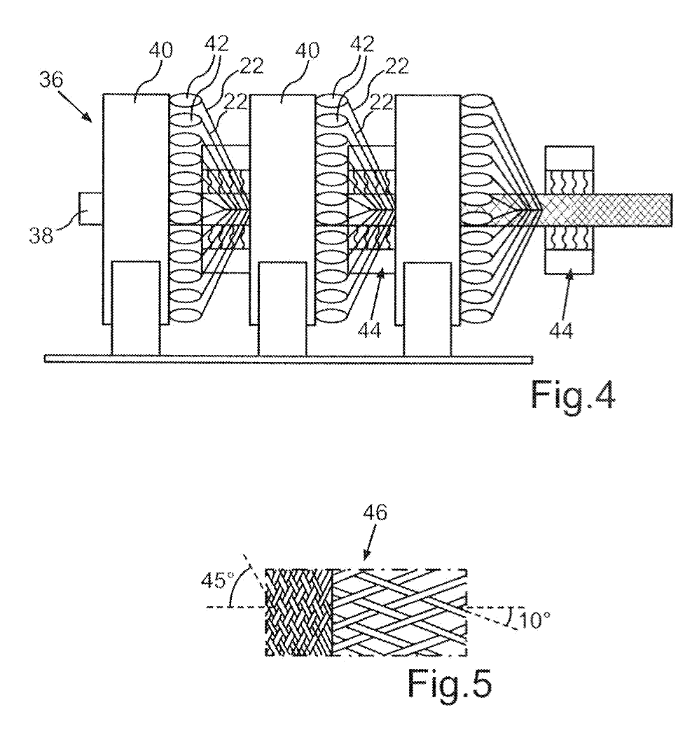

To braid the hollow profile around a durable core, a braiding machine 36, as is depicted in FIG. 4, is used. A plurality of braiding wheels 40, each of which carries a plurality of reels 42, are arranged around the durable core 38. The respective hybrid rovings 22 are unwound from the reels 42 and braided around the core 38. Here, a partial fusing of the material of the matrix fibers 26 can already be achieved by infrared heaters 44. The use of several braiding wheels 40 enables the production of a multilayer braid. In particular, differences in thickness can also hereby be achieved, wherein several layers of the braid are braided over one another in regions of greater stress.

The braiding angle depicted with the aid of a section of the braid 46 can, in such braiding processes, be +/−5° to +/−80°. For reinforcement in the 0-degree direction, which is particularly advantageous in the case of bending loads, additional filler yarns can be added to the braiding wheel. These pass into the braid in an extended manner and thus have barely any undulation. Furthermore, so-called UD braiding can be used, wherein hybrid rovings are braided with pure matrix fibers and the matrix is subsequently fused.

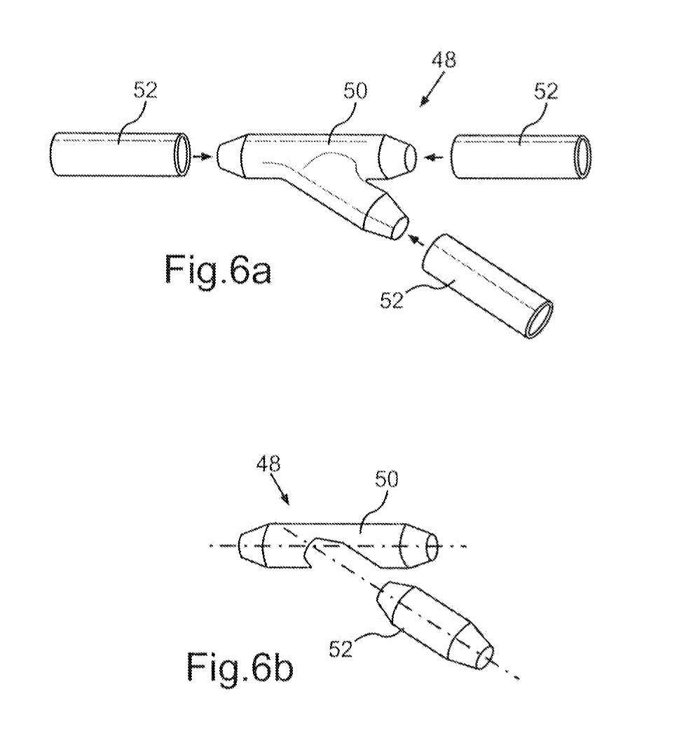

To achieve the branching in the cockpit cross-member 10, a mold core 48 according to FIGS. 6a and 6b is used. The mold core 48 shown in FIG. 6a is constructed in multiple parts and has a branched central piece 50, which can be combined with end pieces 52 to produce the complete core 48. As is shown in FIG. 6b, the branching can also be achieved by inserting an end piece 52 into a corresponding receiver of the central piece 50.

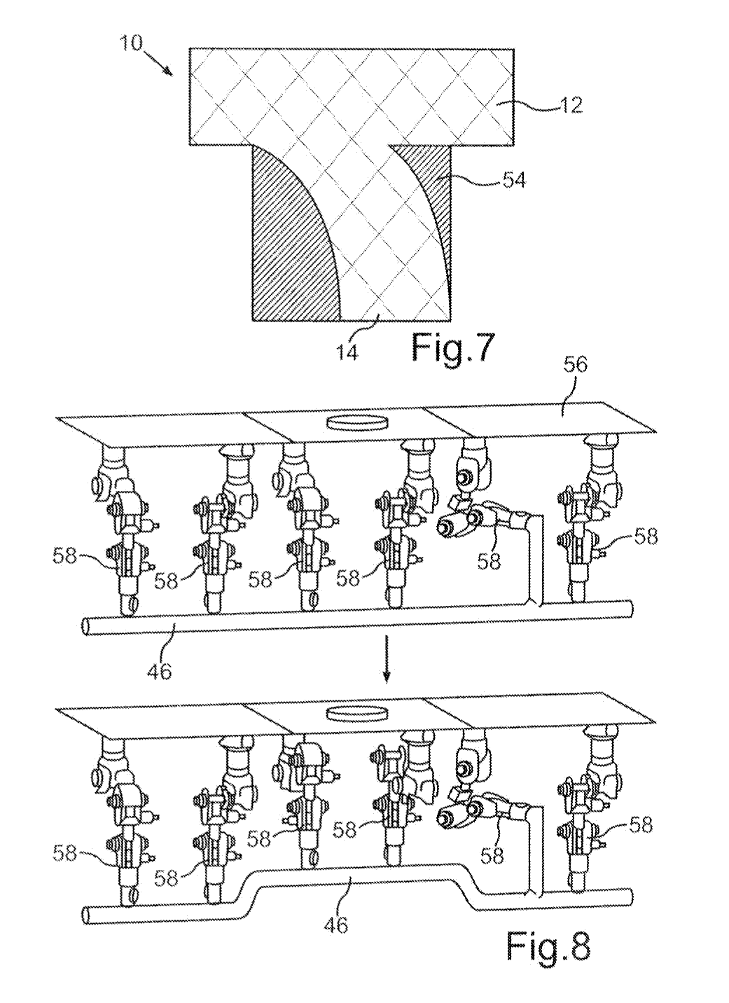

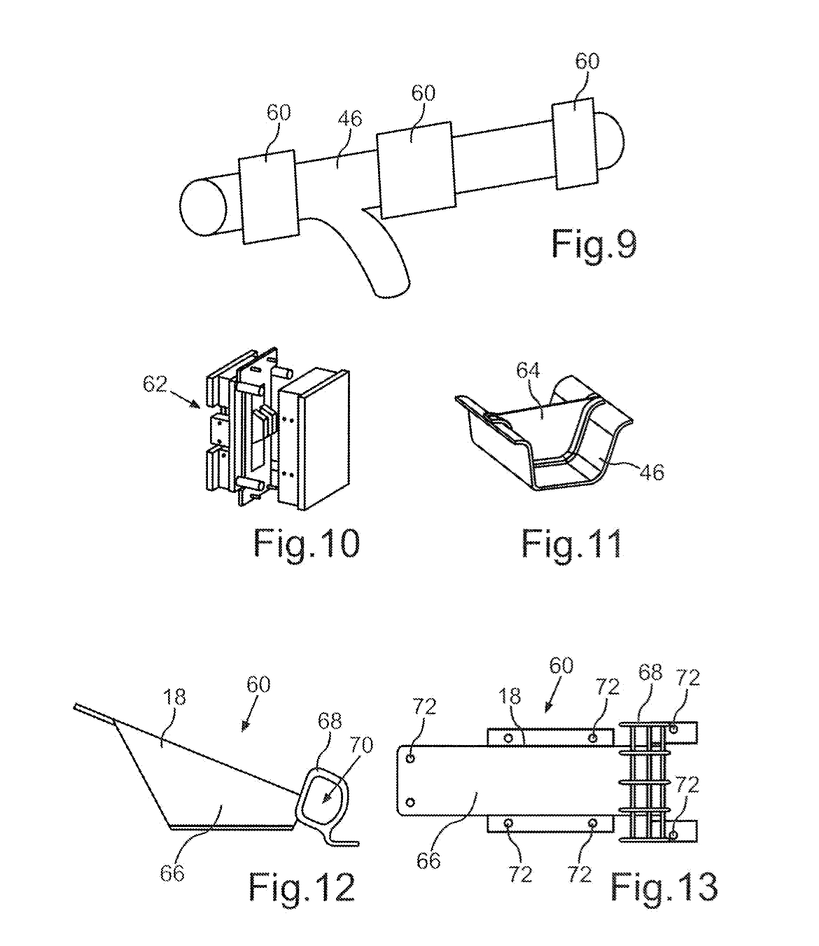

Due to the flexible nature of hybrid rovings 22 or towpregs 32, it is possible to completely braid such a core 48, even in the branching region, and to then still release it from the braid 46 in a non-destructive manner. Should, at greater branching angles, as illustrated in FIG. 7, no complete braiding of the branching region be possible, this can, if necessary, later have an overmold 54 added to it.

After the release of the braid 46 from the core 48, this is, as shown in FIG. 8, held by a handling robot 56. This has a plurality of manipulators 58, which grip the braid 46 and hold it in a position close to the end contour. In this position, the braid 46 is finally inserted into an injection molding machine 62, wherein it is, if necessary, provided at several points with depositors 60 made from a thermoplastic material, said depositors being held in the injection molding tool 62 at the corresponding positions. Before the actual overmolding of the braid 46, the braid 46 has internal pressure applied to it, such that it maintains the desired hollow contour, even during the injection molding. Then the braid 46 and, if necessary, the depositors 60, are overmolded with a thermoplastic compound which can, if necessary, even contain yet more short fibers for further reinforcement. Here, the thermoplastic compound enters the braid 46 and, at the same time, fuses the matrix fibers 26, such that a homogeneous plastic body arises with the desired inner fibrous structure. Also, the depositors 60 produced from thermoplastic material, for example fiber-reinforced plastic, are thus connected firmly to the cross-member, such that a single-part cross-member 10 is created with a high level of functional integration.

When overmolding the braid 46, as depicted in FIG. 11, more reinforcing ribs 64 can additionally be injected as well.

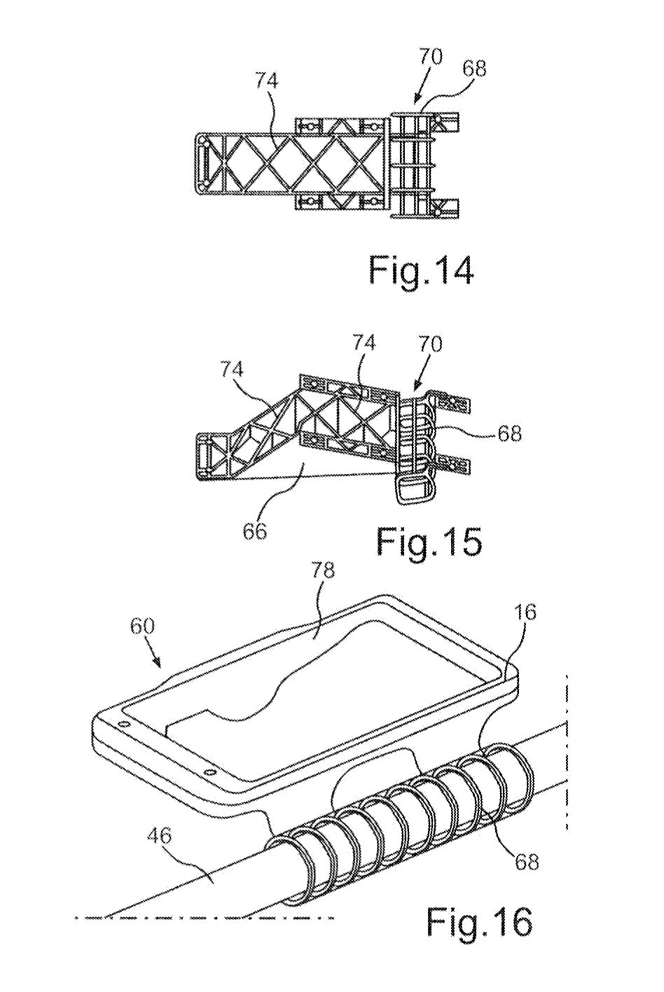

Finally, yet more examples of various forms of depositors 60 are depicted in FIG. 12 to FIG. 16. FIGS. 12 to 15 thus show different views of a depositor 60 for the formation of the steering console 18. The depositor can be constructed from flat organic sheet structures 66, which can be connected to the braid via a plastic rib structure 68 that forms a hollow space 70. Corresponding receiving openings 72 serve to bolt the steering console 18 to components that are to be fastened to it. Also, reinforcing ribs 74 can be provided here, which provide the steering console 18 with particularly good strength.

Finally, FIG. 16 shows a depositor 60 for the formation of the clamp 16 for a passenger airbag. Here, the depositor 60 consists of a rectangularly peripheral frame 78 made from thermoplastic material, which in turn has a fabric rib structure 68 added to it, which receives the braid 46 that is to be overmolded. Here, a firmly bonded connection can also be generated by melting the rib structure 68 during the overmolding, such that a particularly good grip can be achieved as well here.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for the production of a hollow profile, the method comprising:
braiding endless fibers around a core that forms an inner contour of the hollow profile to produce a fibrous hollow structure;
wherein after the braiding and while the fibrous hollow structure in an elastic state
the fibrous hollow structure is removed from the core in a non-destructive manner;
the removed fibrous hollow structure is molded into an end contour by applying internal pressure; and
the molded removed fibrous hollow structure is overmolded with a plastic, wherein the hollow profile is a cockpit cross-member for a motor vehicle.

12. The method of claim 11, wherein the core has at least one branching.

13. The method of claim 11, wherein the fibrous hollow structure is brought into a shape resembling an end contour before the application of internal pressure by means of a robot handling device.

14. The method of claim 11, wherein the endless fibers are hybrid rovings made from reinforcing fibers and thermoplastic matrix fibers.

15. The method of claim 11, wherein the endless fibers are reinforcing fibers coated with thermoplastic matrix material.

16. The method of claim 11, wherein the plastic is a short-fiber-reinforced plastic.

17. The method of claim 11, wherein locally different wall strengths are produced when the fibrous hollow structure is braided.

18. The method of claim 15, wherein before the application of the internal pressure, the fibrous hollow structure is heated to just above a melting point of the matrix material.

19. The method of claim 11, wherein the overmolding with plastic further comprises overmolding with at least one depositor.

20. A hollow profile component, comprising:
a hollow profile having at least one branching, which is reinforced by a continuous, branched fiber network,
wherein the hollow profile component is a cockpit cross-member for a motor vehicle, and
wherein the at least one branching forms a a console or a tunnel brace.
